(19) United States
(12) Patent Application Publication
(10) Pub. No.: US 2026/0284717 A1
(43) Pub. Date: Sep. 24, 2026

(54) ELECTRO-CLEANING DEVICE AND METHOD

(71) Applicant: COMMISSARIAT A L'ENERGIE ATOMIQUE ET AUX ENERGIES ALTERNATIVES, Paris (FR)

(72) Inventors: Arnaud THEVENOT, Le Barp Cedex (FR); Jean-Louis GAUSSEN, Le Barp Cedex (FR); Arnaud PERRIN, Le Barp Cedex (FR)

(73) Assignee: COMMISSARIAT A L'ENERGIE ATOMIQUE ET AUX ENERGIES ALTERNATIVES, Paris (FR)

(21) Appl. No.: 19/478,374

(22) PCT Filed: Apr. 24, 2024
(86) PCT No.: PCT/FR2024/050538

§ 371 Date: Oct. 24, 2025

(30) Foreign Application Priority Data
Apr. 26, 2023 (FR) FR2304218

(51) Int. Cl. B08B 7/02; B08B 9/04; E02B 11/00

(52) U.S. Cl. CPC B08B 7/02; B08B 9/04; B08B 2209/04; E02B 11/005

(57) ABSTRACT

A device for electro-cleaning by indirect attack of a conduit, comprising two electrodes facing each other, applied against an insulating surface; means for generating high-voltage electrical pulses; and means for transmitting and applying the pulses between the two electrodes.

### TECHNICAL FIELD AND PRIOR ART

The present invention relates to a system or device for cleaning a pipe or conduit, for example in a drainage network.

The principle of groundwater drainage aims to reduce the hydraulic load applied to man-made structures or natural spaces intended for agricultural use. It consists of a network of pipes (drains) fitted with fine perforations allowing water to enter said pipes. These pipes can have a slope sufficient for the flow of water to an outlet characterized by a hydraulic load significantly lower than that of the volume to be drained. The material constituting the drains generally has corrosion resistance qualities to ensure longevity.

Modern drains generally consist of flexible plastic tubes.

But a drainage network often becomes clogged gradually.

This is because a set of physicochemical phenomena occur at the interface between the surrounding environment and the inside of the drains. These phenomena result in deposits of solid matter not only inside the pipes but also in the perforations of their wall as well as on the outer surface of these drains (the extrados). The extent of these phenomena sometimes leads to a total loss of drainage system efficiency.

There are two types of phenomena that lead to this clogging:

The first phenomenon is related to the entrainment of soil particles (the “fines”) by the flow of water that is directed towards drains; the fines, whose size is equal to or larger than that of the perforations in the pipes, tend to accumulate on the extrados of the drains. This accumulation results in clogging of some of the perforations and creates hydraulic pressure losses in the drainage water path. This results in a decrease in the flow of water entering the pipes and, overall, a decrease in the efficiency of the drainage system.

The second phenomenon is related to the crystallization, in contact with drains, of elements dissolved in water. This is because, from a hydraulic point of view, the inside of the drains is subject to frequent load variations, in particular depending on seasonal fluctuations. These fluctuations result in an altimetric variation of the water-air interface. The drainage water therefore passes from a medium characterized by a continuous liquid phase (the soil to be drained) to a medium having a liquid phase in contact with a gas phase (the inside of the drains). The existence of this interface leads to a change in natural chemical balances. This is particularly the case with the calcocarbon balance. In a naturally acidic environment with an excess of carbon dioxide, natural carbonates (limestone from geological formations) or anthropogenic carbonates (concretion from structures) are partially dissolved in the form of calcium bicarbonate (Ca(HCO₃)₂). When CO₂ degassing occurs at the water-air interface, the calcocarbon equilibrium shifts and calcium bicarbonate crystallizes as calcite (CaCO₃). Calcite is a hard crystalline mineral species that adheres to all physical supports present: the inner surface of drains, the thickness of their wall at the perforations, the outside of drains and piles of fines. The continuous nature of this phenomenon results in progressive clogging of the drainage systems. In addition to the example of the calcocarbon balance, there are other physicochemical phenomena that lead to the same result.

Several cleaning techniques are traditionally used to eliminate the effects of clogging phenomena: hydrocleaning, mechanical milling, chemical descaling and biological descaling.

Hydrocleaning is the most commonly used technique. This technique involves injecting water under high pressure (100 to 500 bar) through nozzles mounted on an injection head itself attached to the end of an umbilical. The water jets are divided into two categories: axial or lateral jets that aim to destroy deposits and rear jets that aim to both remove the detached products and propel the probe forward.

Mechanical milling involves using a robot generally consisting of a rigid body (usually about 0.4 m long) mounted on a wheel and equipped with an articulated arm carrying a milling cutter. The cutter is driven in rotation electrically or hydraulically.

Chemical descaling involves injecting acid into drains to dissolve the carbonate component of the deposits. This technique is only possible if access to the drains is possible upstream. This method has the disadvantage of polluting discharge into the natural environment.

The biological cleaning technique involves injecting a solution containing a colony of bacteria that secrete an organic acid capable of attacking the carbonated components of deposits. However, as in the previous case, this technique requires access upstream of the drains. In addition, its effectiveness is moderate. A problem with all these techniques is that they only treat deposits that are inside the drains. On the other hand, deposits that obstruct wall perforations and those that accumulate on the extrados are removed very little or not at all by these methods. In addition, as most modern drains are made of plastic, their mechanical strength is often lower than that of the deposits that block them. Thus, the techniques of hydrocleaning (particularly at high pressure) or mechanical milling often result in destruction of the walls of the drains because these methods do not distinguish the material of the deposits compared with that constituting the walls of the drains.

Identical or similar problems may arise in any other pipe or conduit in which or which circulates a fluid or a liquid leading to a deposit of material on the inner surface of this pipe or conduit and/or which at least partially blocks one or more orifices made in this conduit and/or the flow section of this conduit, for example at the intersection with another conduit which connects to the first; likewise, deposits, which may come from the environment in which the pipe or conduit is installed, may occur on a surface outside this pipe or conduit, which may lead to reducing its permeability and/or to a less good performance of the entire system for the discharge of the liquid (for example, for a drainage system, the development of concretion, in particular calcite, in the draining invert reduces its permeability by closing the free space through which the water circulates between the aggregates of the invert; in the long term, the draining invert becomes less efficient upstream of the drains to drain the water).

More generally, the problem arises of finding a new device and a new method for cleaning or cleansing a pipe or conduit in which a liquid flows.

Preferably, this novel method or this novel device is more efficient than the known methods or devices and allows better removal of the solid deposits produced in the conduit or pipe or against the inner and/or outer surface of the wall that delimits this conduit or pipe.

Also preferably, it allows better removal of solid deposits made in a conduit or pipe, such as a drain made of material such as a plastics material, or around such a drain.

### DISCLOSURE OF THE INVENTION

The invention first relates to a conduit electro-cleaning device comprising electrodes, which can for example be applied against an insulating surface, so as to enable the creation of an electric arc on the surface of the insulator that separates the electrodes.

These electrodes enable the creation of an electric arc between them, in a liquid medium into which the device can be brought. In the case of the presence of an insulating surface (so-called “surface” configuration), the arc is generated on the surface of the insulator, between the two electrodes and in contact with the liquid medium. In the case of a so-called “volumetric” configuration, the arc is generated in the liquid medium on the shortest path between the 2 electrodes and the shock wave propagates in this medium.

The surface configuration is advantageous because the so-called “gap” tension is lower than that of the volumetric configuration.

The invention makes it possible to implement an indirect attack, in which an arc is created outside the material to be fractured: it is the shock wave, which impacts the surface of the material to be fractured, which acts against it. The energy is deposited on the surface of the material via the aqueous medium.

On the other hand, direct etching involves creating an arc in the material to be fragmented. Plasma is created in the material and causes it to explode from the inside. Energy is deposited in the material.

According to the invention, indirect etching is carried out, which is more advantageous than direct etching; this is because the latter is more difficult to implement because it requires a good quality contact between the electrodes of the probe and the material to be fragmented, which is impossible in the case of anarchic growth of the material. The electrodes are preferably arranged facing one another and/or face each other.

A device according to the invention may further comprise, or be associated with:
means for generating electrical pulses, for example pulses of power between 10 MW and 60 MW and/or of voltage between 10 kV and 60 kV;
means for transmitting, or for transmitting and applying, said pulses to the electrodes or between the two electrodes.

The technique according to the invention preferentially uses High Pulsed Power (HPP) technology, which makes it possible to compress energy from a quasi-static source into controlled pulses, preferably very dense and very short, preferably still delivering a very high power, for example between 10 MW and 60 MW. High Pulsed Powers are understood to mean the compression of energy, from a “quasi-static” source, into one-stroke pulses or pulses with controlled repetition rates, very dense and very short, thus delivering a very high power.

The pulses can be generated at a frequency of the order of one Hz, or at a higher frequency, which allows the deposited material not to relax sufficiently after each pulse. In other words, the relaxation time is lower than the firing frequency, for example it is several orders of magnitude lower.

A device or method according to the invention makes it possible to implement a hydrodynamic effect, where the electric arc creates a pressure or shock wave in the liquid which will then fracture the solids deposited in or against the wall that delimits the pipe or conduit. The electrodes and the medium to be fragmented are immersed in a continuous aqueous liquid phase, except in the case of a medium to be fragmented located against the pipe or conduit, but outside it (but the continuous aqueous liquid phase is still required for the shock wave to propagate).

This operation is more suitable than the electrohydraulic effect, in which the electric arc breaks the solids by penetration, because the operation according to the invention does not require close physical contact between the electrodes and the substrate to be fragmented.

A device according to the invention may have various geometric shapes.

It can comprise a major axis (XX′), which may be aligned with an axis of flow of a fluid in a pipe. The insulating surface against which the electrodes are applied may be:
plane and perpendicular to said axis (XX′);
or of revolution around said axis.

Preferably, this surface has a high resistivity (for example between 10¹² Ωcm and 10¹⁵ cm).

Moreover, the geometric shape of the device according to the invention can be designed to allow progression of this device in both directions, in a conduit on which deposits, for example concretions, may have been made very irregularly, or even pseudo-chaotically. For example, the probe has on its front face (in the direction of travel of the device in a conduit) a rounded shape and/or corners and/or on its rear face (cable side) a shape, for example conical, favoring its removal including in the case of clumps of debris resulting from the fracturing of the concretions.

Preferably:
a device according to the invention has a general cylindrical shape, with a total outside diameter smaller than that of a pipe or conduit into which it must be introduced;
and/or has an electrode configuration:
so-called “axial”, for treating deposits or concretions that tend to close or obstruct the aperture or flow cross-section of the conduit to be unblocked;
and/or a so-called “parietal” configuration to treat deposits of the concretions developing on the walls of the conduit to be unblocked.

Preferably, the spacing between the electrodes is adjustable, which makes it possible to adjust the threshold voltage and thus the energy of the electric arc that is generated. For example, means are provided for disassembling one and/or the other of the electrodes and for replacing it with an electrode of a different size or diameter, leading to a different inter-electrode spacing.

A device according to the invention may comprise an external profile comprising for example at least one gas discharge groove formed by an arc established between the 2 electrodes. Thus, gases generated by the electric arc do not remain blocked at the level of the inter-electrode space, which would impair the functioning of the device.

In a device according to the invention, the means for generating high-voltage electrical pulses make it possible to, or are able to, generate pulses:
with a voltage which may be between 10 kV and 60 kV.
with an intensity for example between 5 kA and 20 kA,
over a duration for example less than 50 μs.
with a power between 0.1 and 10 GW;

The electrodes may be distant by a uniform distance and/or the device may comprise means for adjusting this distance (d).

A device according to the invention may further comprise:
means for damping shock waves;
and/or means forming a reflector for directing the shock waves.

A method for electro-cleaning a conduit according to the invention may use a device according to the invention as defined above and/or in this application. It can therefore be applied to a conduit delimited by at least one wall and containing a liquid, said wall having a surface partially covered by one or more deposits of solid material to be removed and/or said conduit being at least partially obstructed by at least one deposit of solid material to be removed; a method according to the invention may comprise:
positioning a device according to the invention, as defined above and/or in this application, in said conduit;
generating electrical pulses, preferably at high voltage, to obtain for example a power of between 10 MW and 60 MW and/or a voltage of between 10 kV and 60 kV between the electrodes;
forming an electric arc between the electrodes, on the insulating surface and in the liquid, for example in at least one direction parallel to one or more deposits of solid material to be removed, preferably as close as possible to the concretion to be removed.

The electrical pulses are for example generated by means of an energy bank, then transmitted via a coaxial cable to a probe to obtain for example the aforementioned power and/or voltage between the electrodes of the probe.

For example:
at the probe, the voltage is between 10 kV and 60 kV and the energy delivered is between 100 J and 600 J;
the duration before breakdown (thus before the moment of formation of the arc between the electrodes of the probe) is for example of the order of 10 μs, the complete duration of the arc to evacuate the energy can be of the order of 40 μs.

On this basis, the power, in the sense of the energy flow delivered between the electrodes, may well be between 10 MW and 60 MW.

Preferably, the gases formed following the interaction between the liquid and the electric arc are discharged from the surface of the electro-cleaning device.

According to an example application, the deposits of solid matter to be removed are calcite deposits.

The deposits of solid matter to be removed are for example on an inner surface of the conduit and/or on an outer surface of the conduit and/or at least partially obstruct a flow of the fluid in the conduit.

The conduit is for example made of plastics material or cast iron or ceramic.

For example, the material of the insulating surface has a higher dielectric constant than that of the liquid.

In one or more implementations of a method according to the invention, the voltage pulses:
can be generated at a rate of at least 0.2 Hz to 1 Hertz;
and/or are high-power pulses.

A method according to the invention makes it possible to remove deposits or concretions using electrical pulses of a duration between for example 1 μs and 10 μs at an energy between for example 0.5 KJ and 10 kJ. The voltage applied between the electrodes can for its part be between 10 kV and 50 kV.

These pulses are transmitted via a cable to a sensor inserted in the drain to be cleaned. The drain is immersed in a continuous liquid phase. The sensor has two electrodes between which an electric arc occurs. This arc travels from one electrode to the other following the surface of the insulator separating them.

This electric arc causes a pressure wave in the water which, in turn, fractures and fragments the materials of the deposits and/or concretions to be removed, in particular at the planes separating the substrates of different mechanical impedance. This mechanism causes deposits to detach from the wall of the drains not only on the intrados (inside) and on the extrados (outside) but also at the perforations of the walls and/or the cross-section of flow of the fluid in the pipe, a cross-section which is generally perpendicular to a longitudinal mean axis of the pipe. Overall, thanks to the device and the method according to the invention, all the deposits that obstruct the pipes are fragmented and detached from the walls. Those located inside the drains can then be easily disposed of. Those that are outside remain in place but their fragmentation restores the initial permeability of the natural environment. Thanks to this technique, the efficiency of a drainage system can therefore be restored without degradation of the drain walls.

In a variant, an electro-cleaning system according to the invention is implemented in a so-called volumetric configuration. The arc is generated in the liquid medium along the shortest path between the 2 electrodes and the shock wave propagates in this medium. The voltage/energy/pulse-duration parameters given above and in the remainder of this description can be adapted to this configuration.

Several diameters and probe geometries can be used depending on the diameter of the drain to be unblocked and the nature of the deposit to be destroyed. The probe, regardless of its shape or diameter, has two electrodes separated by an insulator against which they are applied. The gap between the electrodes is adjustable to vary the energy level of the arc. The greater this spacing, the greater the arc energy. This setting allows the choice of an arc power sufficiently large to fracture the calcite or all the material obstructing the drain without however destroying the drain itself.

### BRIEF DESCRIPTION OF THE DRAWINGS

FIG. 1 schematically illustrates an embodiment of a probe according to the present invention.

FIG. 2 shows an example of a probe according to the invention, fitted with its high-voltage cable, and connected to an energy bank.

FIG. 3A, FIG. 3B, FIG. 3C and FIG. 3D show an example of a probe structure according to the invention, a so-called axial type (FIGS. 3A-3B), and an example of a probe structure according to the invention, a so-called parietal type (FIGS. 3C-3D);

FIG. 4 shows an embodiment of an energy bank 14 that can be used in the context of the present invention.

FIG. 5 shows an example embodiment of means for carrying out the charging of a power-supply device to be applied to a probe according to the invention.

FIG. 6 schematically shows a coaxial cable, connected on the one hand to para-supply means and, on the other hand, to an electro-cleaning probe, for example according to the invention.

FIGS. 7A and 7B show an embodiment of a probe according to the invention of the axial geometry type.

FIG. 7C shows an embodiment of a removable electrode for a probe according to the invention of the axial geometry type;

FIG. 8 shows a view of a mechanical clamp of a probe according to the invention.

FIG. 9A and FIG. 9B show an embodiment of a probe according to the invention, of the parietal geometry type.

FIG. 9C shows an embodiment of a removable electrode for a probe according to the invention of the parietal geometry type;

FIG. 10A and FIG. 10B show an embodiment of a probe according to the invention, in a so-called volumetric configuration.

FIGS. 11A and 11B show a view of a device according to the invention, in a surface configuration, with claw-shaped electrodes;

FIG. 12 shows a view of a device according to the invention, in a surface configuration, with a difference in altitude or level between the ends of the electrodes;

FIG. 13 shows an example of implementation of a device according to the invention, in a drain in which concretions have formed.

FIG. 14 shows the principle of high pulsed powers.

FIGS. 15A-15D illustrate the relationship between firing frequency, charging voltage of the energy bank, power of the HV power supply

FIG. 16A and FIG. 16B respectively represent the change in the voltage and current at the cable input, without the probe;

FIG. 16C shows the change in the voltage at the cable input, with the probe;

FIG. 16D shows the change in the energy discharge of the probe. L

FIG. 17 shows a horseshoe-shaped drain.

FIG. 18 shows a view of a device according to the invention, in a surface configuration, provided with a reflector.

### DETAILED DISCLOSURE OF THE INVENTION

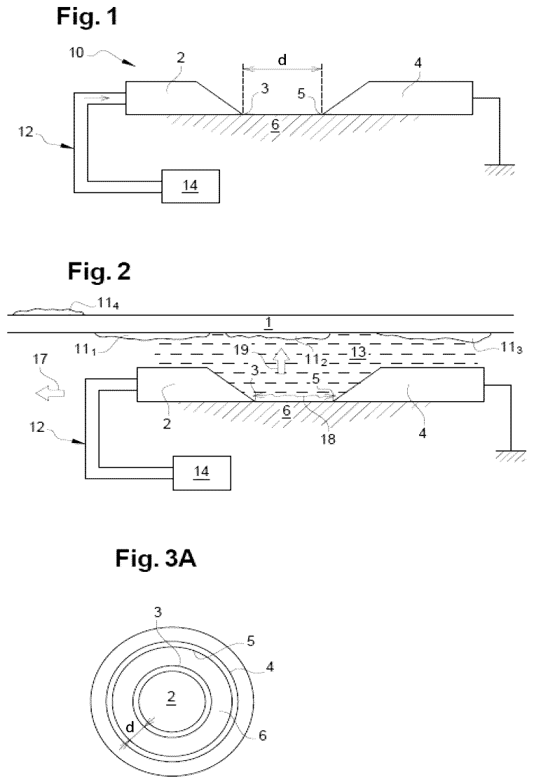

FIG. 1 schematically illustrates a cross-sectional view of a probe 10 that can be used in the context of an embodiment according to the present invention.

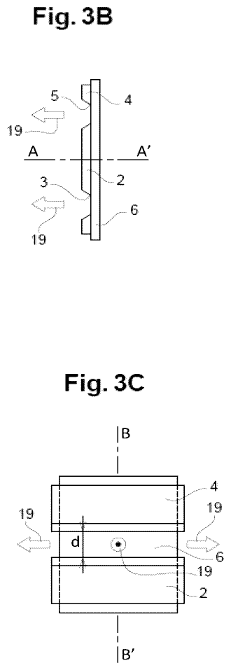

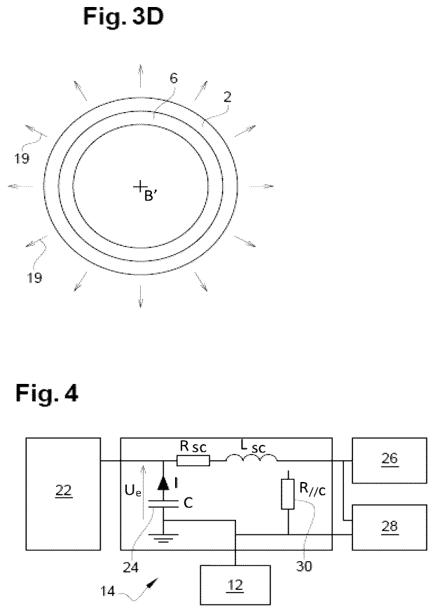

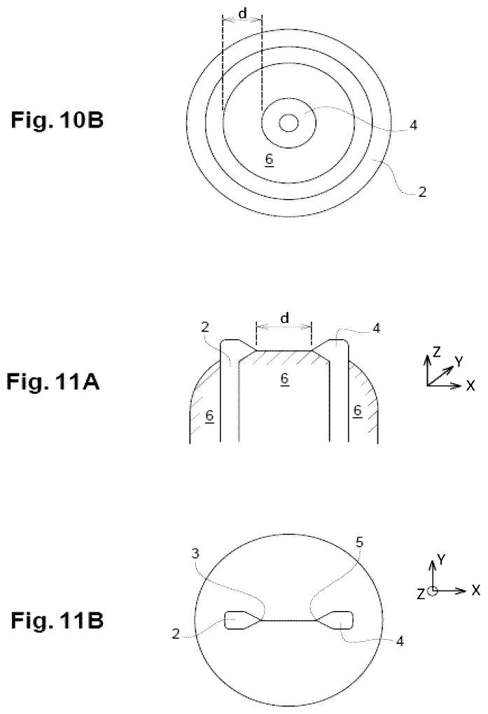

Two electrodes 2, 4 are arranged facing each other (their ends face at a distance d) and the surface of an insulating material 6. These electrodes may have various geometries and/or symmetries, as explained below in connection with FIGS. 3A-3D and 7A-9C. The ones of FIG. 2 may extend along the direction perpendicular to the figure while maintaining the distance therebetween. They are arranged against the insulating material 6 and so that electric arcs can be generated between them and on the surface of this insulating material. For example, they may have tips 3, 5 positioned against the surface of the insulating material 6 and between which the arcs will be able to be generated. The embodiment of FIG. 1 relates to a so-called “surface” configuration. Further on, in connection with FIG. 10A and FIG. 10B, another configuration, called “volumetric”, is presented. For the manufacture of the electrodes, a non-oxidizable material will preferably be selected, for example stainless steel, for example again a steel of the type 316 L.

The distance d between these 2 electrodes is for example between a few mm and 1 or 2 cm, for example between 5 mm and 1 cm. This distance may be variable in order to take account of different voltage values and/or in order to vary the level or threshold of energy or voltage from which the arc will be triggered between the electrodes: for example, at least one of the electrodes may be mounted removably in order to be able it to be replaced by another electrode of a different geometric shape so that the distance d is different. This can be very useful if, for example, a greater energy is available (for example due to more powerful means 14, described below in connection with FIG. 4) to be applied between the electrodes: the distance d between them can then be increased to form an arc whose energy is sufficiently large to fracture the materials deposited on the wall to be cleaned, without however damaging the latter. This concern of not damaging the wall can be particularly sensitive in the case where it is made of a material such as a plastic material (this may be the case in particular for a drain). In other words, the adjustment of the distance d between the electrodes can take into account both the energy available to be applied between them and the mechanical strength of the wall to be cleaned.

One of the electrodes (4) may be connected to ground while a high voltage may be applied to the other electrode (2), for example via a high voltage cable 12, for example a coaxial cable; preferably, this cable also allows grounding of the electrode 4. This cable may be intended to be connected, on the other side (opposite to the electrodes 2, 4), to a high voltage (HV) source 14, or high voltage (HV) energy bank, which makes it possible to generate pulses at high voltage.

The probe is connected to its power supply cable 12 which transmits the high voltage and which is generally quite inflexible. It is therefore possible to push or pull this HV cable manually or mechanically in order to move the probe in the conduit or drain to be treated. If the cable is too flexible, any other means can be associated (needle, water-jet thruster, robot, etc.) to move the probe in a conduit or drain. According to another aspect, it may be preferable, before any cleaning operation of a device according to the invention, to perform an inspection, for example by a video camera, of the conduit or pipe or drain to be treated to identify the position of the deposits to be destroyed. Thus it can be determined at what depth in the drain the area to be treated is located. The probe can then be inserted to the previously identified locations.

In general, the probe can be propelled and pulled by means of the semi-rigid HV cable. The action is performed either manually or with the help of a remotely controlled mechanical device that acts on the cable.

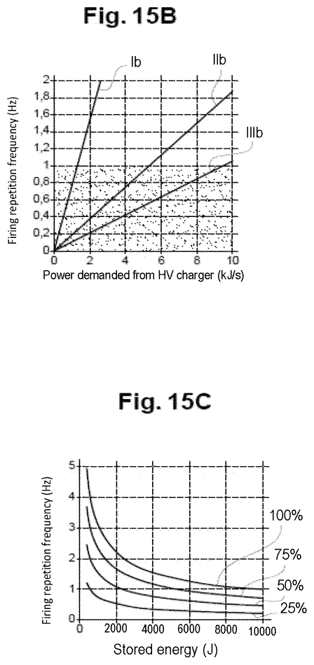

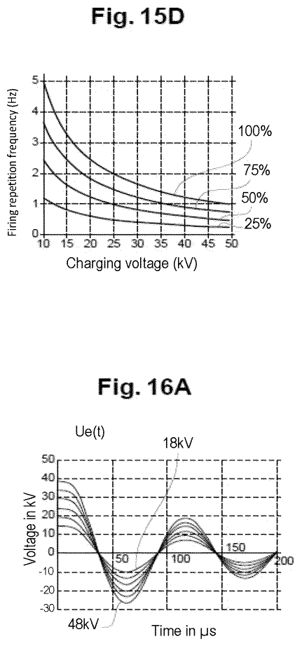

For example (see in this regard the curves of FIGS. 15A to 15B), the electrical pulses are voltage pulses between 10 kV and 60 kV or even between 10 kV and 100 kV, for example again of the order of 20 kV (note that these are indeed the voltages between the electrodes). The values to be selected are chosen according, in particular, to the nature of the drain in which the probe must operate and its strength (too high a voltage or power may result in degradation of the drain).

The pulses can have:
a duration in the order of a few microseconds, for example 5 μs, more generally for example between 1 μs and 10 μs,
and/or the energy delivered per pulse may be between 100 J and 600 J.

From a time point of view, it can also be indicated that:
the time between the application of the voltage and the breakdown (i.e. the formation of the arc between the electrodes of the probe) may be for example of the order of 10 μs;
and/or the complete duration of the arc to discharge the energy may be in the order of 40 μs;
and/or the arc may be effective within 10 μs after breakdown.

The pulses can therefore have a power which will be between, for example, 10 MW and 60 MW.

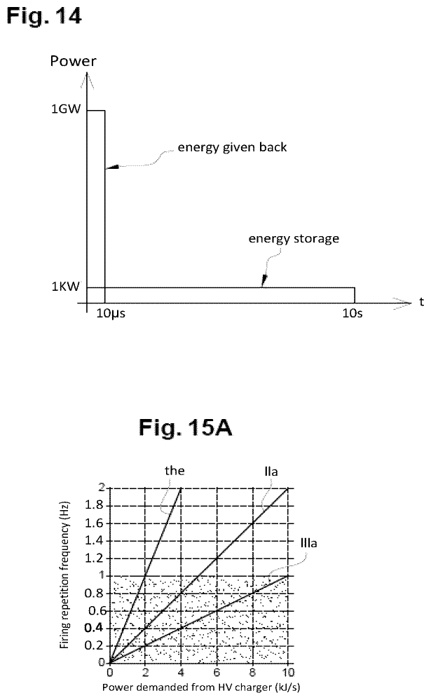

The invention preferably uses the High Pulsed Power (HPP) technology, which makes it possible to compress energy from a quasi-static source into controlled pulses, preferably very dense and very short, preferably again delivering a very high power, for example between 10 MW and 60 MW. High Pulsed Powers are understood to mean the compression of energy, from a so-called “quasi-static” source, into one-stroke pulses or pulses with controlled repetition rates, very dense and very short, thus delivering a very high power. FIG. 14 illustrates this aspect; in this figure:
slow storage of a power of 1 kW for 10 seconds equals 1 kJ energy;
when this energy is installed for a very short time, of the order of 10 μs, the power given back is 1 GW.

As explained later, the pulse generator includes a capacitor that stores the energy in capacitive form. Its charging is slow, from a thousandth of a second to a few tens of seconds. It is carried out by means of a high-voltage supply and charging means (or “bank”). The charging bank protects the high voltage (HV) supply from power returns. Once the capacitor is charged, it is used to decouple the low-voltage part from the high-voltage part. The stored energy is then switched through a controlled air spark gap. It allows rapidly giving back the energy to the electrodes connected by a coaxial cable.

In fact, the firing frequency depends on the ability of the HV power supply to charge the power bank in a sustainable manner (without reducing the service life of the HV power supply). The curves in FIGS. 15A-15D illustrate the relationship between firing frequency, load voltage of the power bank, power of the HV power supply.

Thus, it can be seen in FIGS. 15A-15B that:

FIG. 15A: the repetition frequency is between a value slightly higher than 0 hz (for example 0.1 Hz), and 1 Hz, the power demanded from the charger varying between a value slightly higher than 0 KJ/s and 10 kJ/s, for an energy successively equal to 2 KJ (22.1 kV, curve Ia), 5 kJ (35 kV, curve IIa), 10 kJ (49.4 kV, curve IIIa);

FIG. 15B: the repetition frequency is between a value slightly higher than 0 Hz (for example 0.1 Hz), and 1 Hz, the power demanded from the charger varying between a value slightly higher than 0 kJ/s and 10 KJ/s, for an energy successively equal to 1.3 kJ (18 kV, curve Ib), 5.3 KJ (36 kV, curve IIb), 9.5 kJ (48 kV, curve IIIb).

FIGS. 15C and 15D also give the repetition frequency of the firings, lying here between about 0.3 Hz and 5 Hz, depending on the stored energy (FIG. 15C) and the charging voltage (FIG. 15D), for a power of the charger ranging from 25% to 100%.

The insulator 6 preferably has a dielectric constant higher than that of the medium in which the arc will be produced. The material constituting this insulator 6 is for example based on polymer(s) (polyurethane resistivity range between 10¹² Ωcm to 10¹⁵ Ωcm).

The same material can be used for the HV cables.

In general, in order for the arc to occur on the surface of the insulator, the breakdown voltage of the insulator 6 is selected higher than the maximum “gap” voltage (minimum voltage which allows creating an arc between the electrodes) of 60 kV or even 100 kV.

Thus, preferably, the breakdown voltage is selected so that the arc does not form in the insulator; preferably again, it is higher than that of the liquid in which the probe is immersed so that the arc forms in the liquid and not in the insulator.

FIG. 2 schematically shows a probe according to the invention, in a continuous liquid medium 13, for example water. It is provided with its high-voltage cable 12, for example a coaxial cable, and connected to the HV energy bank 14 (the latter being located outside the liquid medium). As indicated above, this cable 12 will also make it possible to push or pull the probe in the medium 13. The probe is located here opposite a wall 1 of a conduit (only the upper part of the longitudinal section of a conduit is shown), for example of a drain, on the inner surface of which deposits 11₁, 11₂, 11₃ of solid matter, for example calcite, have formed over time. These deposits 11₁, 11₂, 11₃ are here shown inside the conduit, but deposits 11₄ may also be made on the outer surface; as already indicated above, these deposits may reduce the permeability of the draining medium in which the conduit is placed (for example a drain). Deposits (not shown) may also occur in perforations of the wall, for example at the intersection between 2 conduits, for example perpendicular to one another. According to another aspect, openings, for example slots, may be pierced on the surface of the conduit (particularly in the case of a drain) to allow the flow of the liquid, for example water, from the medium to be drained to the inside of the drain: if these slots are blocked, the efficiency of the drain is reduced accordingly.

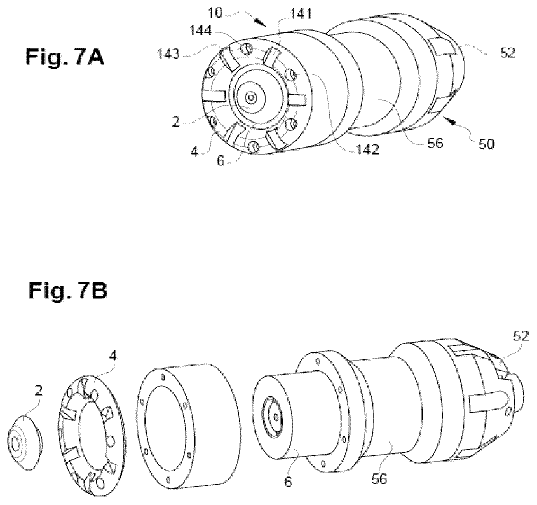

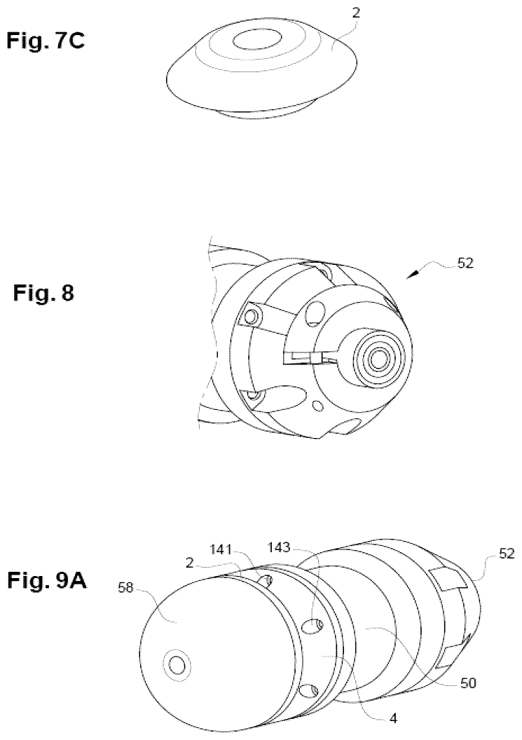

In general, as is understood from FIG. 2, for the sake of efficiency, the arc is sought to be as close as possible to the material to be fractured. For this reason, the electrodes of the probe are preferably provided in a position as far as possible outside the probe casing (see the configurations described below in connection with FIGS. 7A-9C). In practice, the probe is approached as close as possible to the material and is pulled. According to one example, the range of a probe used made it possible, in 180 successive high-voltage shots, to fracture calcite to a depth ranging from 5 to 15 cm.

The application of the voltage pulses will generate an electric arc 18 between the two electrodes 2 and 4, more precisely between the tips 3 and 5. This arc travels from one electrode to the other following the surface of the insulator 6, in the liquid medium 13 that separates them. In the case of a so-called “volume” configuration, the arc is created between the electrodes 2, 4 following the shortest path (an example of this configuration is given below, in connection with FIGS. 10A-10B). The advantage of the surface configuration is to allow the use of a more moderate arc-forming voltage and to reduce the risks of destruction of the insulating material 6 that separates the cathode from the anode: the risk is, in fact, that the “gap” voltage in the water is greater than that at the water/insulator surface; as a result, the insulator on the entire electrical circuit is then designed with higher resistivity (in order to avoid the arc forming in the insulator and destroying it). In fact, this phenomenon is likely to occur at all points with a potential insulation weakness from the generator 14 to the probe 10.

The electric arc 18 thus created causes a vaporization of part of the liquid, which creates a pressure wave 19 in the liquid 13, which in turn, fractures and fragments the material of the solid material deposit(s) 11₁, 11₂, 11₃, 11₄ to which it is directed, in particular at the planes separating the substrates of different mechanical impedance; this may be the case in particular when the material to be removed has a different mechanical impedance to that of the substrate on which it is deposited or formed, for example in the case of a calcite concretion formed on a plastic drain (which is flexible): the shock wave can then deform the flexible drain, this deformation detaching the calcite, which will therefore not be fractured but detached. By moving the probe in the pipe (movement symbolized by arrow 17, for example by the semi-rigid nature of the cable which allows pushing the probe), the probe will be positioned successively in front of the various deposits and will be able to fragment them as explained above. This treatment therefore causes the deposits 11₁, 11₂, 11₃, 11₄ to detach from the wall of the drains not only on the intrados (the inside) and the extrados (the outside) but also at the perforations (not shown in the figure) of the walls 1. The walls 1 suffer no damage. In addition, detached deposits can be fragmented due to their heterogeneous structure, for example due to seasonal fluctuations that affect their crystallization kinetics.

Thus, deposits that obstruct a pipe or drain can be fragmented and detached from the walls 1. The material of the deposits, such as the deposits 11₁, 11₂, 11₃, which are located inside, on the liquid side 13, can then be easily removed, for example by the circulation of the liquid 13. Those (11₄) that are outside the wall 1 can remain in place but their fragmentation can make it possible to restore the initial permeability of the natural environment. Thanks to this technique, the efficiency of a piping system, in particular a drainage system, can therefore be restored without degradation of the wall(s) 1.

FIGS. 3A-3B show an example of a structure of a probe according to the invention, a structure in which the insulating element 6 has a substantially planar shape, the electrodes 2, 4, deposited on a surface of this element 6 having, for its part, a substantially circular shape; more precisely, the electrode 2 has the shape of a disk, whereas the electrode 4 has the shape of a circular ring whose center is occupied by the electrode 2. This structure will emit pressure waves 19 from a ring-shaped area (with a width d as indicated in FIG. 3A) and following a direction substantially perpendicular to the plane of the insulating element 6, parallel to an axis AA′ and in a substantially cylindrical distribution around this axis.

FIGS. 3C-3D show another example of a structure of a probe according to the invention, a structure in which the insulating element 6 has a substantially cylindrical shape, of axis BB′, the electrodes 2, 4 deposited on a surface of this element 6 also having this cylindrical shape. This structure will emit pressure waves 19 from a cylinder-shaped area (with a width d as indicated in FIG. 3C) following a direction substantially perpendicular to an axis AA′ and in a substantially cylindrical distribution around this axis.

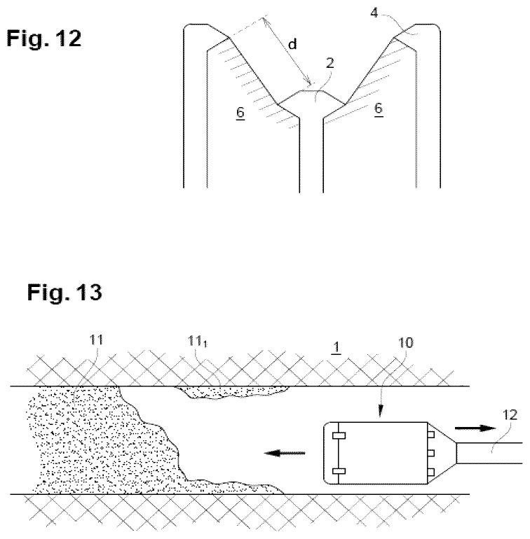

A probe according to the invention is not limited to these structures of FIGS. 3A-3D, other geometries may be used according to the needs; for example, the element 6 may have a cone-shaped surface (see the example described below in connection with FIG. 12), as well as the electrodes deposited on this surface, thus producing shock waves also distributed along a cone.

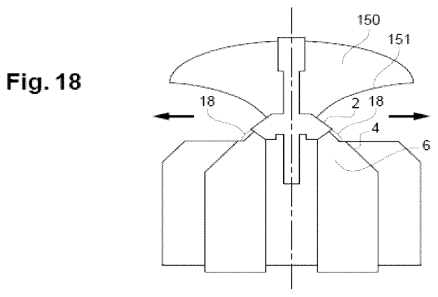

More generally, various shapes may be used to orient the shock wave in the desired manner. For example, the profile of the probe may be given a shape comprising one or more cavities or convexities. A reflector 150 may also be provided to direct the waves towards the desired surface, as illustrated in FIG. 18. In this figure, the element 6 has a cone-shaped surface, but inverted with respect to that of FIG. 12. The electrodes deposited on this surface have the same shape. The reflector 150 has for example a parabolic generator 151. It directs the shock waves perpendicular to the probe axis.

In the various configurations illustrated, the electrodes are parallel to each other: their ends face a distance d that remains constant over their entire extension.

According to one embodiment, illustrated in FIG. 4, the HV generator 14 may comprise a high-voltage generator 22 connected to an HV capacitor 24. The capacitor 24 itself is part of an RLC circuit (see resistor R_{SC}, and inductor L_{SC}) connected to an HV spark gap 26 fulfilling a switch function. Means 28, for example a relay, forming a short-circuit, may be provided in order to ensure safety, to discharge the energy of the capacitor in the event of a problem, for example related to a safety issue; the resistor 30 is a leakage resistor.

The energy bank 14 can be connected to the HV cable 12.

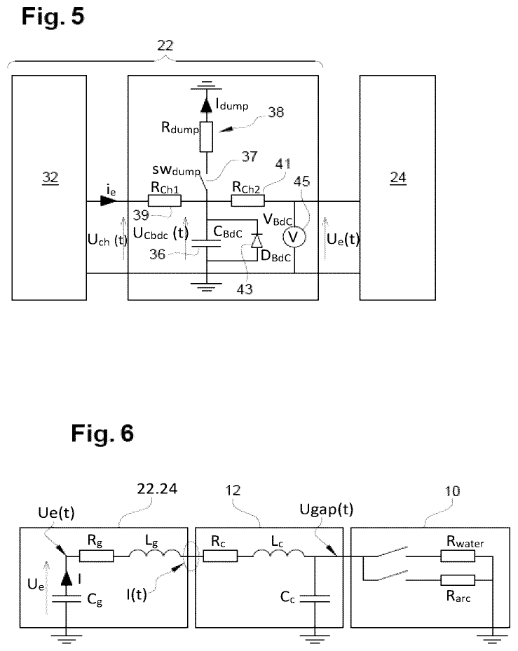

FIG. 5 shows an example embodiment of a generator 22, comprising a high-voltage charger 32 (for example made by BASIS EUROFEEDBACK, model ACRX Series), which makes it possible to charge a capacitor 36. A switch 37 can connect it to a dump resistor 38 (R_{dump}, or “dump load”), whose role is, if necessary, to discharge the energy bank without creating damage to the capacitors.

The generator 22 makes it possible to:
transfer electrical energy from the HV charger 32 to the HV capacitor 24, which makes it possible to charge the capacitors at the voltage Uₑ. This function is carried out via the load resistors R_{Ch1} (ref 39) and R_{Ch2} (ref 41);
damp any reverse voltage coming from the load to protect the HV 35 charger. This function is performed via the RC filter comprising R_{Ch2} and C_{Bdc} (ref 36), then the RC filter comprising R_{Ch1} and C_{Bdc}.
empty the energy of the HV capacitor through a dump resistor (R_{dump}) when a pneumatic cylinder is activated.

This assembly makes it possible to supply a voltage Uₑ(t) to the capacitor 24 during charging.

FIG. 6 schematically shows the coaxial cable 12, connected on the one hand to the pulse generator 22, 24 and, on the other hand, to a probe 10, which may be of the type according to the invention.

Examples of values used are as follows:
a) simulation parameters:
charging voltage Ue: 18-48 kV;
inter-electrode resistance of the liquid: dx 10 Ω;
generator inductance: Lg=1.05 μH;
generator resistance: Rg=50 mΩ;
b) cable parameters:
cable inductance: Lc=0.094 μH/m;
cable resistance: Rc=3.1 mΩ/m;
stray capacitance: cc=361 pF/m;
arc assistance: 12 mΩ/mm (for a gap of 5 mm);
time before breakdown: Tb=10 μs.

When using a device according to the invention:
the capacitor 24 is charged by each high voltage pulse generated by the means 22;
the means 26 allow discharging the capacitor 24 in the coaxial cable 12.

All of the means described above can be connected to a processing and/or control unit which makes it possible in particular to control the triggering of the high-voltage pulses and the triggering of the spark gap 26. This unit also makes it possible to perform measurements, for example current and/or voltage, in order to better control them. The processing and/or control unit includes for example a computer or a microcomputer or a microprocessor which makes it possible to implement processing and/or control functions of a device and a method according to the invention.

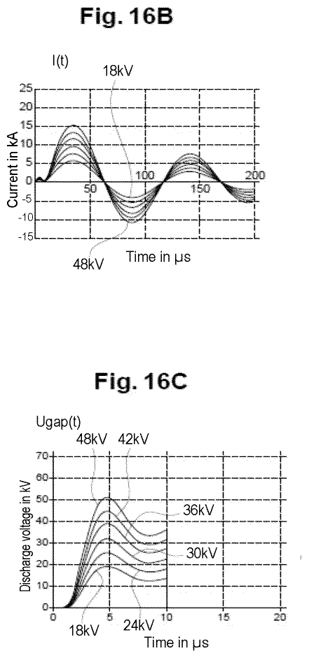

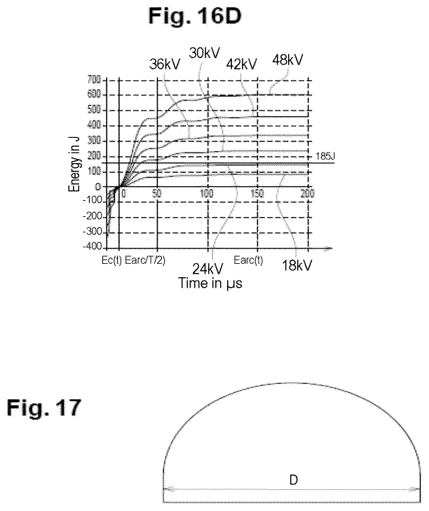

FIGS. 16A to 16B show simulations of discharge curves, (at the energy bank (see FIG. 6) in voltage Ue and current i(t) respectively with a coaxial cable 12 of 150 ml, of 8 μF, for voltages ranging from 10 kV to 48 kV (more precisely: 18 kV, 24 kV, 30 kV, 36 kV, 42 kV, 48 kV).

On these figures, it is noted that the voltage Ue at the terminal of the energy bank and Ugap at the terminals of the probe are not the same. They are phase shifted (RCL circuit between the two measurement points) before the arc is created.

FIG. 16C shows the change in the voltage Ugap at the probe, again with a 150 ml coaxial cable 12 of 8 μF; it can be seen that the voltage suddenly decreases when the arc is triggered, which occurs here at t=10 μs.

FIG. 16D shows the change in the energy discharge of the probe (Earc(t)=Ugap(t)·I(t)·t−Ec(t)): after the end of the arc, there is still a signal; this is because, based on the equivalent electrical diagram of the circuit (FIG. 6), it is understood that, once the arc has disappeared (the “switch arc” open), there is always the resistance of the water (Rwater with closed switch) which makes it possible to discharge the residual energy accumulated in the system.

FIGS. 7A and 7B show an embodiment of a probe according to the invention, of the so-called axial geometry type, FIG. 7B showing a view of the disassembled device. This is an embodiment in which each of the electrodes 2, 4, as well as the surface of the insulator 6 that separates these 2 electrodes, have a rotational symmetry about an axis XX′. An arc triggered between these 2 electrodes also has this symmetry around the axis XX′.

According to this example embodiment, the probe includes a body 50 which can be broken down between a central part, or body 56, with rotational symmetry about an axis XX′ and one or more other parts 52, which can be removable (they can be fastened, for example by screwing, against or on the central body 56). The high voltage cable 12 (not visible in these figures) can be introduced into the central part of the probe body.

The electrode 2 faces the electrode 4, which can be connected to a ground connection. The device may be equipped with one or more dampers of the shock waves (which, generated by the probe, propagate both in the liquid and in the probe body and can therefore damage the internal components of the latter). One practical solution is to select the material of the insulator 6 so that it dampens all or part of these shock waves.

The electrode 2 and/or 4 may be removable; it may therefore be removed and replaced with an electrode having a different diameter, in order to increase or decrease the distance between the electrodes 2, 4. FIG. 7C shows such a removable electrode 2. The adjustment of the gap voltage for an axial probe configuration can be obtained by modifying the diameter of this central electrode 2.

The arcs that will be generated between the electrodes 2 and 4 of such a probe will make it possible to generate shock waves in the liquid that will more particularly be emitted in the direction of the axis XX′ of the probe. For this reason, this configuration is called an “axial” type: the surface of the insulator 6 in contact with the liquid medium is substantially perpendicular to the axis XX′.

Advantageously, grooves 141, 143 can be made in the electrode 4, between the screwing points 142, 144 thereof against the central body. These grooves extend radially, from the part of the electrode 4 that is in contact with the insulator 6 to the outside of the probe: these grooves make it possible to remove gas, which would result from the interaction between any arc 18 and the liquid 13 in which the probe is immersed. If residual gas, for example in the form of bubbles, were to stagnate in the inter-electrode area, it would disturb the operation of the probe because it would change the electrical properties of the entire system between the electrodes; for this reason, it is preferable to provide one or more lateral grooves 141.143 for discharging these gases. Preferably, several of these lateral grooves 141, 143 are provided, arranged symmetrically about the axis XX′.

As can be seen in this figure, the probe may have, on the front face, a rounded shape and/or rounded angles that promote its movement in a liquid. FIG. 8 shows the mechanical flange 52 attached to the central body 56 (opposite to the electrodes 2, 4). This flange is used, for example, to mechanically hold the cable on the sensor. The conical shape at least partially facilitates removal of the probe from a conduit into which it has been inserted.

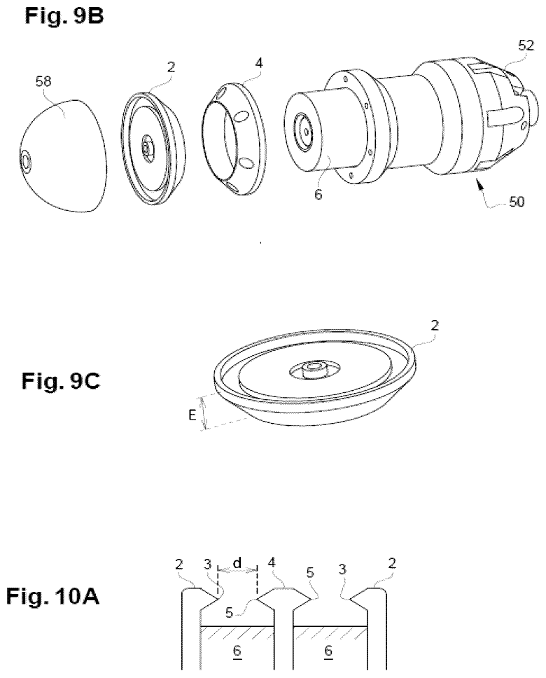

FIG. 9A shows an embodiment of a probe according to the invention of the so-called “parietal” geometry type. This is an embodiment in which each of the electrodes 2, 4, as well as the surface of the insulator 6 that separates these 2 electrodes, are disposed laterally to the probe, while having a rotational symmetry about the axis XX′ thereof. An arc triggered between these 2 electrodes extends over a certain distance, parallel to the axis XX′ and with this symmetry around it. References identical to those of FIGS. 7A-7B denote on these FIGS. 9A-9B elements identical or similar to those already described above. But the electrodes 2, 4 are disposed on the cylindrical lateral portion of the body, in the front portion and terminate with a dome 58, for example made of polymer material. Here again the electrode 2 and/or 4 may be removable; it may therefore be removed and replaced by an electrode having a different lateral extension, in order to increase or reduce the distance between the electrodes 2, 4. FIG. 9C shows such a removable electrode 2. The adjustment of the gap voltage for a parietal probe configuration can be done by modifying the thickness E of this end electrode 2.

The arcs that will be generated between the electrodes 2 and 4 of such a probe will make it possible to generate shock waves in the liquid which will more particularly be emitted perpendicularly to the axis XX′ of the probe. For this reason, this configuration is called a “parietal” type: the surface of the insulator 6 in contact with the liquid medium is substantially cylindrical or conical, or of revolution around XX′, parallel or coaxial to the axis XX′.

In such a structure, the flow of liquid, which flows substantially parallel to the axis XX′, makes it possible to eliminate the gases that can result from the interaction between the arc 18, generated between the electrodes 2.4, and the liquid 13, in which the probe is immersed. But, as in the previous case, grooves can be provided to improve the discharge of these gases. For example, such lateral grooves (not shown in FIGS. 9A-9B) are made in the electrode 4, between the screwing areas 141, 143; they can extend over a portion of the central body 56.

A probe according to the invention is not limited solely to the configurations described above in connection with FIGS. 7A-9C. Such a probe may comprise electrodes oriented differently, in order to reach surfaces which may have a particular orientation in a liquid-circulation conduit.

The distance between the probe and the drain is not managed. The probe rests on the drain waterline and is held laterally by the drain. Here, the horseshoe-shaped drain (shown in FIG. 17) has a diameter D between 11 cm and 15 cm. The probe has a diameter of 10 cm.

The invention was described above in the context of a so-called “surface” configuration, wherein the electrodes are directly in contact with an insulating surface 6. In another configuration, shown schematically in FIG. 10A (side, cross-sectional view) and 10B (plan view), the ends 3, 5 of the electrodes 2, 4, between which an arc can occur, are not in direct contact with the insulating surface 6: this one is retracted with respect to the electrodes. In the configuration shown in FIG. 10A, an electrode 2 is ring- or annulus-shaped, and another electrode 4, central, is stud-or disk-shaped, disposed at the center of the ring or annulus. But other variants may be implemented, without departing from the scope of the present invention. This volume configuration may be applied to the various variants described above in connection with FIGS. 4-9.

Regardless of the adopted configuration, surface or volume, the ends of the electrodes 2, 4 may have a claw shape, as shown in FIG. 11A for a surface configuration (viewed from above in FIG. 11B): according to 2 or 3 directions of space, they extend towards a tip-shaped end 3, 5. Electrodes with this shape promote arc formation. The same shape can be applied to the volume configuration.

Again as an alternative, shown in FIG. 12, the electrodes may be located at different levels, with an insulating material having for example a conical shape. In this figure, the end of the cone has a concave shape, but a convex shape could be implemented, allowing the formation of waves with an oblique propagation direction relative to the axis of the device.

Finally, FIG. 13 shows a probe 10 according to the invention, positioned in a drain 1 in which both parietal concretions 111 and axial concretions 11 have formed, which will be able to be removed by the probe. The other numerical references are those of the figures described above.

The invention applies to any pipe or conduit in which or which a fluid or a liquid flows, leading to a deposit of material on the inner and/or outer surface of this pipe or conduit and/or which at least partially blocks one or more orifice(s) made in this conduit and/or the cross-section of flow of this conduit, for example at the intersection with another conduit that connects to the first; likewise, the invention applies in the case of deposits which may come from the environment in which the pipe or conduit is installed and which may occur on a surface external to this pipe or conduit, which may lead to reduced permeability thereof and/or to less good performance of the entire system for the discharge of the liquid (e.g., for a drainage system, the development of concretion in the matrix of the draining invert reduces its permeability; in the long term, the draining invert becomes less efficient upstream of the drains to drain water).

1. A device for electro-cleaning of a conduit by indirect attack, comprising:
two electrodes facing each other, applied against an insulating surface;
means for generating high-voltage electrical pulses; and
means for transmitting and applying said pulses between the two electrodes.

2. The device according to claim 1, wherein the electrodes are applied against an insulating surface so as to allow the creation of an electric arc at the surface of the insulator that separates the electrodes.

3. The device according to claim 2, further comprising a major axis, wherein the insulating surface against which the electrodes are applied is planar and perpendicular to said axis

4. The device according to claim 2, further comprising a major axis, wherein the insulating surface against which the electrodes are applied is of revolution about said axis.

5. The device according to claim 1, wherein the electrodes are distant by a uniform distance or the device comprising means for adjusting the distance.

6. The device according to claim 1, further comprising at least one groove for discharging gas formed by an arc established between the two electrodes.

7. The device according to claim 1, wherein the means for generating the high-voltage electrical pulses generates pulses with a power between 10 MW and 60 MW.

8. The device according to claim 1, wherein the means for generating the high-voltage electrical pulses generates pulses of high power and/or voltage between 10 kV and 60 kV.

9. The device according to claim 1, further comprising means for damping shock waves.

10. The device according to claim 1, further comprising means for forming a reflector to direct the shock waves.

11. A method for electro-cleaning a conduit delimited by at least one wall and containing a liquid, said wall having a surface partially covered by at least one deposit of solid material to be removed and/or said conduit being at least partially obstructed by at least one deposit of solid material to be removed, said method comprising:
positioning the device according to claim 1 in said conduit;
generating the high-voltage electrical pulses and transmitting the high-voltage electrical pulses to the electrodes, and
forming an electric arc between the electrodes, on the insulating surface and in the liquid, following at least one direction parallel to at least one of the deposits of material to be removed.

12. The method according to claim 11, wherein the pulses have a power between 10 MW and 60 MW.

13. The method according to claim 11, wherein the electrical pulses are pulses with a voltage between 10 kV and 60 kV.

14. The method according to claim 11, wherein gases formed following the interaction between the liquid and the electric arc are discharged from the surface of the electro-cleaning device.

15. The method according to claim 11, wherein the deposits of solid material to be removed are calcite deposits.

16. The method according to claim 11, wherein at least one deposit of solid material to be removed is on an inner surface of the conduit or on an outer surface of the conduit and/or blocks at least part of a cross-section of flow of said conduit.

17. The method according to claim 11, wherein the conduit is made of plastics material or cast iron or ceramic.

18. The method according to claim 11, wherein the material of the insulating surface has a higher dielectric constant than that of the liquid.

19. The method according to claim 11, wherein the voltage pulses are generated at a rate of at least 0.2 Hz to 1 Hertz.

20. The method according to claim 11, wherein the voltage pulses are high-power pulses.
